(19) United States
(12) Patent Application Publication
(10) Pub. No.: US 2012/0185528 A1
(43) Pub. Date: Jul. 19, 2012

(54) SESSION ALLOCATION FOR DISTRIBUTED VIRTUAL DESKTOP ARCHITECTURE

(75) Inventors: Joe Jaudon, Sedalia, CO (US); David Lowrey, Denver, CO (US); Adam Williams, Aurora, CO (US)

(73) Assignee: Aventura HQ, Inc., Denver, CO (US)

(21) Appl. No.: 13/334,963

(22) Filed: Dec. 22, 2011

Related U.S. Application Data
(60) Provisional application No. 61/426,320, filed on Dec. 22, 2010.

(51) Int. Cl. G06F 15/16

(52) U.S. Cl. 709/203

(57) ABSTRACT

Methods, systems, and devices are described for allocating sessions in a distributed virtual desktop architecture. Multiple machines may each be configured to host at least one operating session and provide an input/output functionality. A data store may store a set of rules for identifying a session machine to host an operating system session associated with a user. A server computer system may be communicatively coupled with the data store and with each of the machines. The server computer system may authenticate the user at a first machine, enforce the set of rules to identify a session machine from the plurality of machines to host an operating system associated with the user, and instruct the first machine to communicate with the identified session machine such that the input/output functionality provided by the first machine is mapped to the operating system session associated with the user at the session machine.

### CROSS REFERENCES

The present application claims priority to U.S. Provisional Patent Application No. 61/426,320, filed Dec. 22, 2010, entitled “DISTRIBUTED VIRTUAL DESKTOP ARCHITECTURE,” which is incorporated by reference in its entirety for all purposes.

### BACKGROUND

This invention relates to computer network communication, and more particularly, to a distributed virtual desktop architecture. Various computer systems may use a thin-client or a virtual desktop display in conjunction with a centralized server computer system or mainframe, and also use traditional workstations and handheld devices.

Virtualization is a logical representation of a computer in software. By decoupling the physical hardware from aspects of operation, virtualization may provide more operational flexibility and increase the utilization rate of the underlying physical hardware. Although virtualization is implemented primarily in software, many modern microprocessors now include hardware features explicitly designed to improve the efficiency of the virtualization process.

In traditional architectures, a virtual desktop display can be served to client devices from a server computer system. The server may receive input and output over a network or other communication medium established between the device and the server. In some examples, a thin-client device may run web browsers or remote desktop software, such that significant processing may occur on the server.

A full-function server computer system can be a significant expense for companies deploying a virtual desktop architecture. Thus, there may be a need in the art for alternative system architectures that mitigate the need for such investments by better utilizing existing computing resources of the company.

### SUMMARY

Methods, systems, and devices are described for providing distributed virtual desktops by using a server computer system to perform rules-based allocation of user operating system sessions to host machines. The input/output functionality of machines associated with individual users may then be individually mapped to the operating system sessions associated with the users on the host machines.

In a first set of embodiments, a system includes multiple machines, a data store, and a server computer system. Each machine may be configured to host at least one operating system session and provide an input/output functionality. The data store may be configured to store a set of rules for identifying a session machine from the plurality of machines to host an operating system session associated with a user. The server computer system may be communicatively coupled with the data store and each of the machines. The server computer system may be configured to authenticate a first user at a first of the machines, enforce the set of rules to identify a session machine to host an operating system associated with the user, and instruct the first machine to communicate with the identified session machine such that the input/output functionality provided by the first machine is mapped to the operating system session associated with the user at the session machine.

In a second set of embodiments, a method of providing a distributed virtual desktop includes authenticating a user of a first machine communicatively coupled with a server computer system; enforcing a set of rules to identify a session machine communicatively coupled with the server computer system to host an operating system session associated with the user; and instructing the first machine to communicate with the second machine such that the input/output functionality provided by the first machine is mapped to the operating system session associated with the first user at the second machine.

In a third set of embodiments, a server computer system includes a user authentication module, a session machine selection module, and a mapping module. The user authentication module is configured to authenticate a user of a first machine communicatively coupled with the server computer system. The session machine selection module is configured to enforce a set of rules to identify a session machine communicatively coupled with the server computer system to host an operating system session associated with the user. The mapping module is configured to instruct the first machine to communicate with the session machine such that the input/output functionality provided by the first machine is mapped to the operating system session associated with the user at the session machine.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example system including components configured according to various embodiments of the invention.

FIG. 2A is a block diagram of an example system including components configured according to various embodiments of the invention.

FIG. 2B is a block diagram of an example system including components configured according to various embodiments of the invention.

FIG. 2C is a block diagram of an example system including components configured according to various embodiments of the invention.

FIG. 3 is a block diagram of an example system including components configured according to various embodiments of the invention.

FIG. 4 is a block diagram of an example system including components configured according to various embodiments of the invention.

FIG. 5 is a block diagram of an example table mapping input/output functionality for operating system sessions to machines hosting the operating system sessions, according to various embodiments of the invention.

FIG. 6 is a block diagram of an example system including components configured according to various embodiments of the invention.

FIG. 7A is a block diagram of an example server computer system according to various embodiments of the invention.

FIG. 7B is a block diagram of an example server computer system according to various embodiments of the invention.

FIG. 8 is a block diagram of an example machine according to various embodiments of the invention.

FIG. 9 is a flowchart diagram of an example method of providing a distributed virtual desktop according to various embodiments of the invention.

FIG. 10 is a flowchart diagram of an example method of providing a distributed virtual desktop according to various embodiments of the invention.

FIG. 11 is a flowchart diagram of an example method of providing a distributed virtual desktop according to various embodiments of the invention.

FIG. 12 is a flowchart diagram of an example method of providing a distributed virtual desktop according to various embodiments of the invention.

FIG. 13 a schematic diagram that illustrates a representative device structure that may be used in various embodiments of the present invention.

### DETAILED DESCRIPTION OF THE INVENTION

Methods, systems, and devices are disclosed for providing one or more distributed virtual desktops. Multiple machines may be communicatively coupled with a server computer system. Each machine may be capable of executing and hosting an operating system session and providing input/output functionality. The input/output functionality of each machine may be decoupled from any operating system session hosted by that machine. The server computer system may enforce a set of rules to identify a session machine to host an operating system session associated with the user. The session machine may be selected based on, for example, an identity of the user, a location of the user or the session machine, whether an operating system session associated with the user currently exists, an amount of processing resources available from candidate machines, and the like. The first machine may receive the instruction to communicate with the session machine such that the input/output functionality provided by the first machine is mapped to the operating system session at the session machine.

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

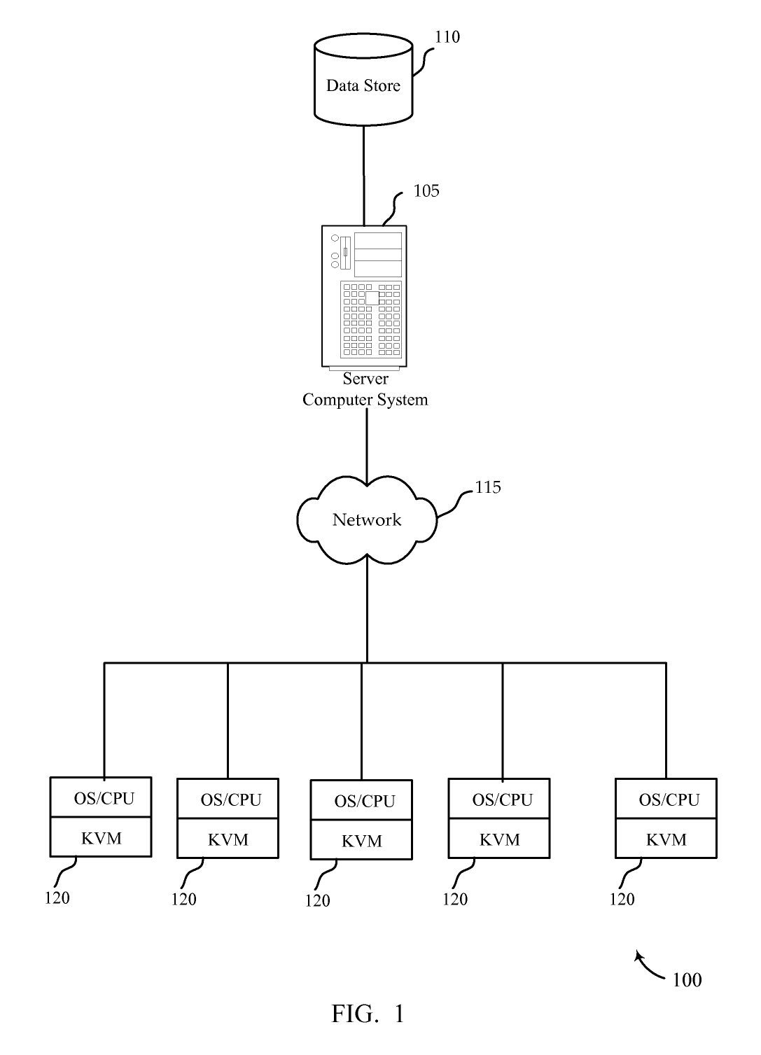

Systems, devices, methods, and software are described for a distributed virtual desktop architecture. In one set of embodiments, shown in FIG. 1, system 100 includes a server computer system 105, data store 110, network 115, and machines 120. Each of these components may be in communication with each other, directly or indirectly.

The machines 120 may communicate with each other over the network 115. Each of these networked machines 120 may be configured to run one or more operating system sessions (e.g., running the operating system (OS) using a CPU and memory) for one or more users, while the keyboard, video, and mouse (KVM) and/or other input/output functions are untied from the machine 120 running the session and allowed to roam with a user. The server computer system 105 may allocate sessions to specific machines 120 in the network. A machine 120 may be a personal computer, laptop, tablet, personal digital assistant (PDA), thin client, mobile device, cellular telephone, or any other computing device, and may have wired or wireless connections.

The server computer system 105 may include a session manager and rules engine to allocate and manage sessions within the network. The server computer system 105 may be made up of one or more server computers, workstations, web servers, or other suitable computing devices. The server computer system 105 may be fully located within a single facility or distributed geographically, in which case a network may be used to integrate different components. Although the illustrated embodiment shows that a separate server computer system 105 performs the allocation and management, in other examples these functions may be performed by a virtual server, resident in whole or in part on one of the machines 120, or distributed among machines 120.

The rules for allocating a user session to a particular machine 120 may be stored locally by the server computer system 105, or may be stored (in whole or in part) at data store 110. Data store 110 may be a single database, or may be made up of any number of separate and distinct databases. The data store 110 may include one, or more, relational databases or components of relational databases (e.g., tables), object databases, or components of object databases, spreadsheets, text files, internal software lists, or any other type of data structure suitable for storing data. Thus, it should be appreciated that a data store 110 may each be multiple data storages (of the same or different type), or may share a common data storage with other data stores. Although in some embodiments the data store 110 may be distinct from a server computer system 105, in other embodiments the data store 110 may be integrated into the server computer system 105 to varying degrees.

The rules for allocating a user session to a particular machine 120 may be based on a number of selection criteria. For example, one or more rules may govern the selection of a session machine to host an operating system session for a particular user based on the identity of the user. The user may, for example, be associated with one or more preferred or default machines to which priority is given in the selection of the session machine. Additionally or alternatively, a type of work performed by the user may have a bearing on which machines 120 may be suitable session machines to host an operating system session for the user. For example, the user may frequently use special-purpose software that is only available on a certain type of operating system. In such cases, rules governing the selection of a session machine for the user may favor machines having that operating system and/or the special-purpose software installed.

In additional or alternative examples, one or more rules may affect the selection of the session machine for the user session based on a set of security permissions associated with the user. Thus, if a machine 120 requires a set of permissions not granted to the user, the one or more rules may prevent that machine 120 from selection as the session machine. Conversely, if the user requires a machine 120 with a certain level of security to perform a particular task, one or more rules may ensure that the session machine is selected from a pool of candidate machines 120 having that level of security or higher.

In additional or alternative examples, one or more rules may be enforced to allocate a user operating system session to a machine 120 based at least in part on a location of the machine 120 with respect to the user. For example, a session machine may be selected from a pool of machines 120 that are associated with a particular area of a building and/or within a threshold distance of a location of the user.

In still other examples, one or more rules may be enforced to allocate a user operating system session to a machine 120 based at least in part on the processing resources, other hardware resources, and/or software resources provided at the machine 120, and/or an availability of these resources. For instance, one or more rules may provide for the selection of a machine 120 to host the user operating system session only if the selected machine 120 has at least a threshold amount of processing resources available to dedicate to the operating system session.

In addition to the foregoing examples, any other selection criterion that may suit a particular implementation of the principles described herein may be incorporated into the rules used to select a session machine to host an operating system session for a user.

A user may log on to a machine 120 (e.g., with a password, a key card, key fob, biometric sign-in, etc.), and the machine 120 may query the server computer system 105 about the user. The server computer system 105 may direct an operating system session to be started on the machine 120 the user logged into, or on another machine 120. The machine's operating system, CPU, and memory may be partially or entirely decoupled from the keyboard, video, and mouse (KVM) functions, and/or other input/output functions, so that the user may have KVM and/or other input/output functionality at the machine 120 hosting the operating system session, or another machine 120. In certain examples, the KVM and/or other input/output functionality of a machine 120 to which the user has logged in may be entirely mapped to the machine 120 hosting the operating system session associated with the user. Alternatively, a portion of the KVM and/or other input/output functionality of the machine 120 to which the user has logged in may remain mapped to the machine to which the user has logged in for the purpose of logging in and out.

If the machine 120 hosting the operating system session is different from the machine 120 to which the user has logged in, the machine 120 to which the user has logged in may communicate with the machine 120 hosting the operating system session over the network 115 such that the KVM and/or other input/output functionality of the machine 120 to which the user has logged in is mapped to the operating system session associated with the user.

When a user logs out of a machine 120 providing the KVM or other input/output functionality for an operating system session, the operating system session may be maintained on the machine 120 running the session (e.g., for a system specified time period, a user-specified time period, a user specific time period, or indefinitely). The user may log on to a machine 120 (the same, or different computer, from the previous log on), and the machine 120 may query the server computer system 105 about the user. The server computer system 105 may direct a connection between the machine 120 running the session and the machine 120 where the user logged in. This connection can be direct between computers, through a network, or via the server computer system 105. The user may then have KVM or other input/output functionality on the machine 120 where he or she is logged in, while a different machine 120 is hosting the session.

In some embodiments, each machine 120 may be configured to run only one operating system session at a time (e.g., for purposes of complying with a license agreement). In other embodiments, a single machine 120 may run a number of operating system sessions, or a session may be distributed over multiple computers. In some embodiments, an operating system session may remain on a single machine 120 until the operating system session is terminated or removed. In other embodiments, aspects of the operating system session may be moved dynamically (i.e., balanced) among one or more of the machines 120 as a load on a system changes.

The components of the system 100 may be directly connected, or may be connected via the network 115. The network 115 may be any combination of the following: the Internet, an IP network, an intranet, a wide-area network (“WAN”), a local-area network (“LAN”), a virtual private network, the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically. If no specific means of connection is noted, it may be assumed that the link, communication, or other connection between devices may be via a network.

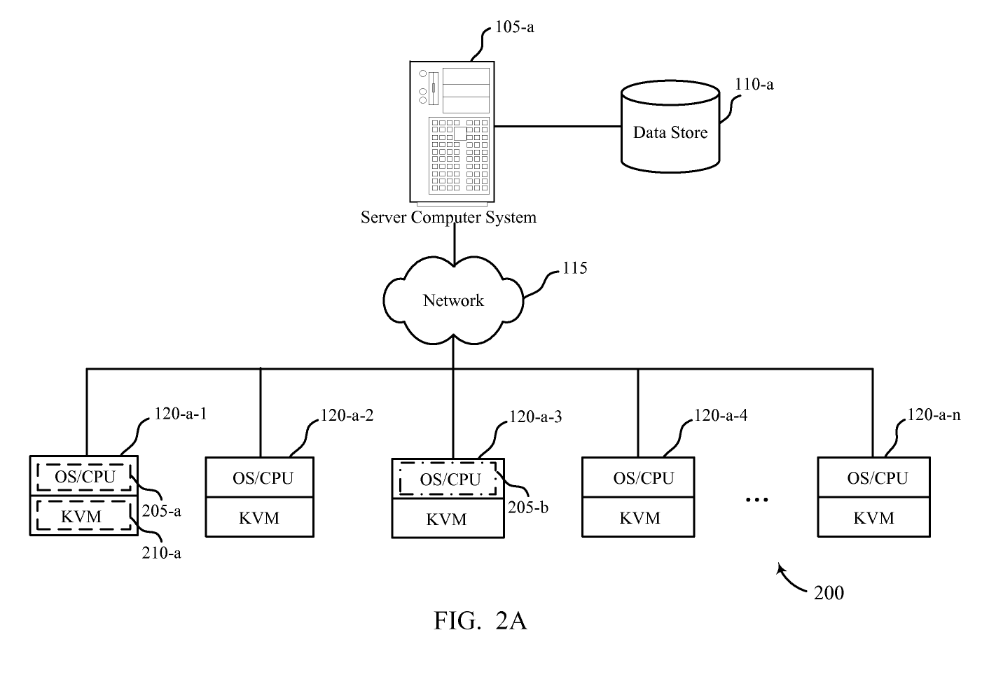

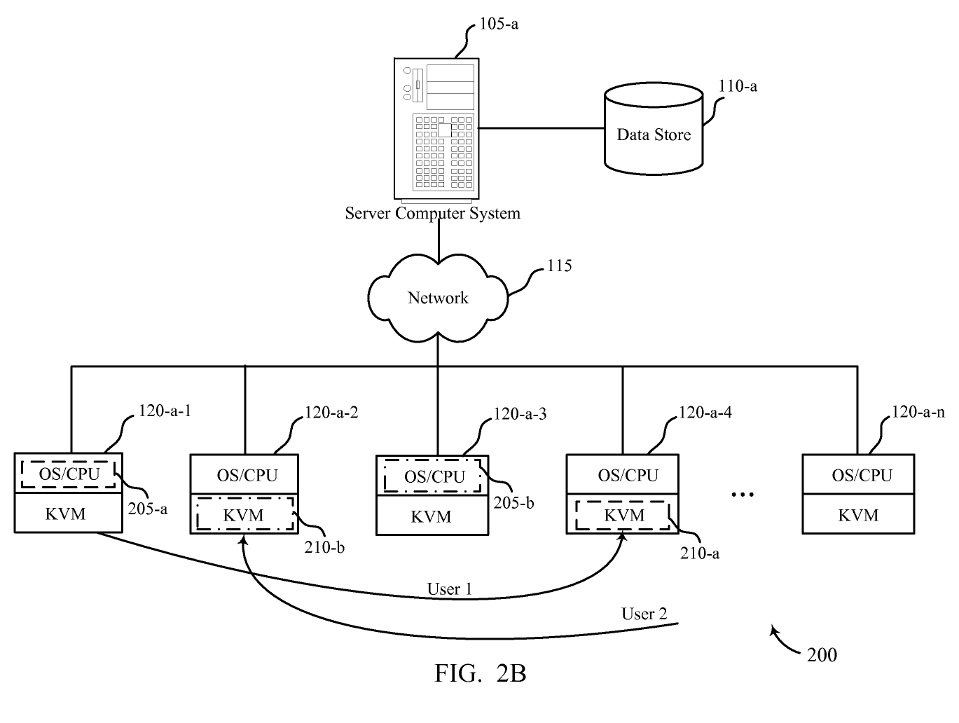

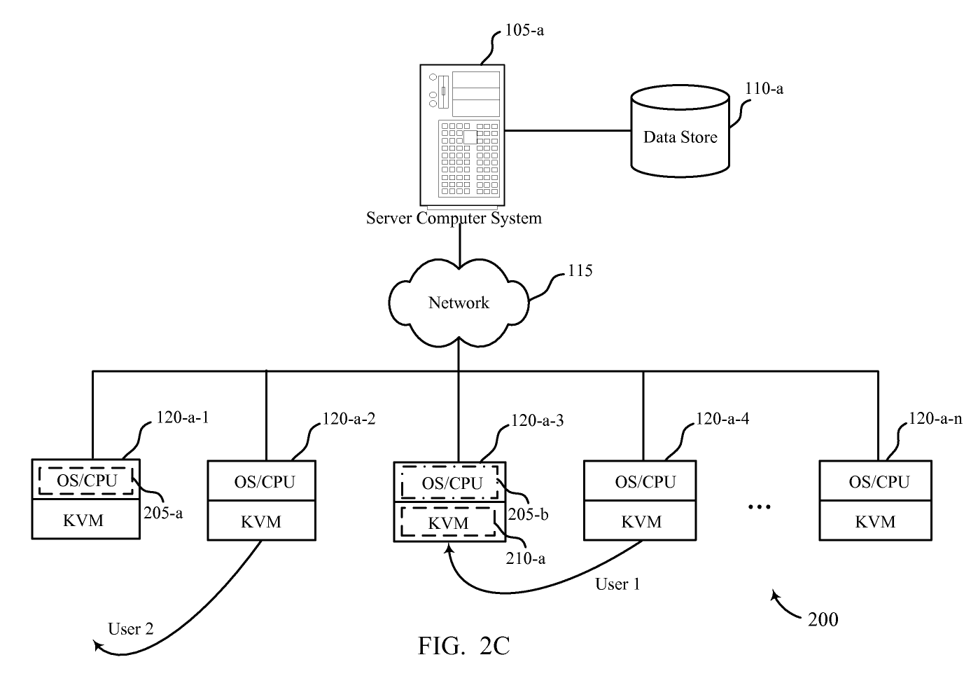

Turning next to FIGS. 2A-2C, these diagrams illustrate an example of the system 100 of FIG. 1. System 200 includes server computer system 105-a and machines 120. Each of these components may be in communication with each other, directly or indirectly.

Referring first to FIG. 2A of the system 200 at an initial period of time, user 1 logs onto machine 120-a-1. The machine 120-a-1 may query the server computer system 105-a about the user, and the server computer system 105-a may authenticate the user and check to see if the user has a current operating system session running The server computer system 105-a may apply a set of one or more rules at a rules engine to select machine 120-a-1 as the session machine for the user and direct machine 120-a-1 to initialize an operating system session 205-a for user 1.

The operating system, CPU, and memory functions dedicated to that operating system session may be controlled independently from the keyboard, video, and mouse (KVM) functions 210-a of machine 120-a-1. Thus, while user 1 may at first access the operating system session 205-a associated with user 1 on the first machine 120-a-1 using the KVM functions 210-a of the first machine 120-a-1, the KVM functions 210-a of the first machine 120-a-1 may be separable from the operating system, CPU, and memory functions dedicated to that operating system session. For example, at a later time the KVM functions of another machine 120-a may be mapped to the first machine 120-a-1 to control operating system session 205-a, and the KVM functions of the first machine 120-a-1 may be mapped to control a different operating system session at a different machine 120-a.

As further shown in FIG. 2A, user 2 may have an operating system session 205-b running on machine 120-a-3. However, user 2 may not be currently logged into any of the machines 120-a, and thus none of the machines 120-a may be currently providing KVM functions to the operating system session 205-b associated with user 2.

Referring next to FIG. 2B of the system 200 at a later period of time, user 1 may log off of machine 120-a-1, move to machine 120-a-4, and log on to machine 120-a-4. The machine 120-a-4 may query the server computer system 105-a about user 1, and the server computer system 105-a may authenticate user 1 and determine that user 1 has a current operating system session 205-a running on machine 120-a-1. The server computer system 105-a may enforce a set of one or more rules to determine that machine 120-a-1 is to remain as the session machine hosting operating system session 205-a. The server computer system 105-a may direct a connection to be made between machine 120-a-1 and machine 120-a-4. The KVM functions 210-a at machine 120-a-4 may then be mapped to the operating system session 205-a running on machine 120-a-1. Through the dynamic switching of KVM functionality facilitated by the server computer system 105-a, user 1 may access and control the operating system session 205-a running on the first machine 120-a-1 while user 1 is using the KVM controls of the fourth machine 120-a-4.

As further shown in FIG. 2B, user 2 may have a session 205-b running on machine 120-a-3, but log in at machine 120-a-2. The machine 120-a-2 may query the server computer system 105-a about user 2, and the server computer system 105-a may authenticate user 2 and determine that user 2 has a current session 205-b running on machine 120-a-3. The server computer system 105-a may enforce a set of one or more rules to select machine 120-a-3 to continue as the session machine hosting operating system session 205-b. The server computer system 105-a may accordingly direct a connection to be made between machine 120-a-2 and machine 120-a-3. The KVM functions 210-b at machine 120-a-2 may then be mapped to the operating system session 205-b running on machine 120-a-3, thereby allowing user 2 to access and control the operating system session 205-b running on machine 120-a-3 from machine 120-a-2.

Referring next to FIG. 2C of the system 200 at a still later period of time, user 2 may log off of machine 120-a-2, but the session 205-b associated with user 2 may be maintained on machine 120-a-3. User 1 may log off of machine 120-a-4, moving to machine 120-a-3 and log back on at machine 120-a-3. The machine 120-a-3 may query the server computer system 105-a about the user, and the server computer system 105-a may authenticate the user and determine that the user still has a current session 205-a running on machine 120-a-1. The server computer system 105-a may apply the one or more rules to select machine 120-a-1 to continue hosting the operating system session 205-a and direct a connection to be made between machine 120-a-1 and machine 120-a-3, such that the KVM functions 210-a of machine 120-a-3 are mapped to the operating system session 205-a running on machine 120-a-1.

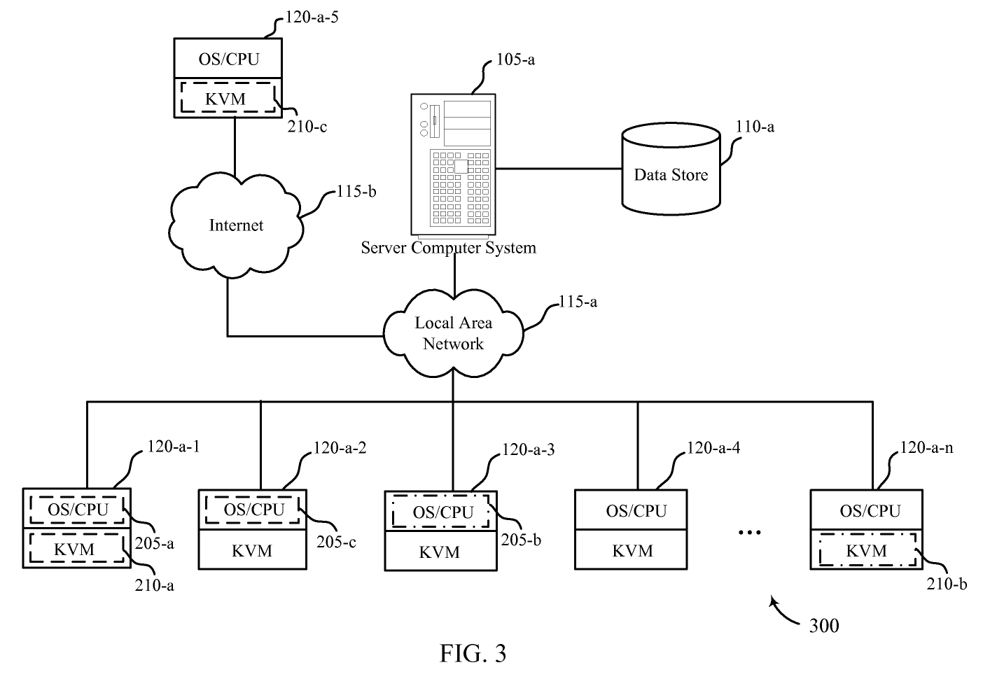

FIG. 3 illustrates another example of a system 300 for distributing desktops. The system 300 may be an example of the system 100 or 200 described above with reference to

FIG. 1 or FIG. 2. The system 300 includes server computer system 105-a, local area network 115-a, the Internet 115-b, and machines 120-a.

In the present example, machines 120-a-1 through 120-a-n, with the exception of remote machine 120-a-5, are communicatively coupled with local area network 115-a. The remote machine 120-a-5 may be indirectly coupled to the other machines 120-a via the Internet 115-b and the local area network 115-a. In certain examples, the remote machine 120-a-5 may be assigned to a remote user who does not have direct access to the local area network 115-a. As shown in FIG. 3, a first operating system session 205-a may be hosted on the operating system, CPU, and memory of machine 120-a-1, and KVM functionality 210-a for the first operating system session 210-a may also be provided by machine 120-a-1. A second operating system session 205-b may be hosted by the operating system, CPU, and memory of machine 120-a-3, and the KVM functionality 210-b for the second operating system session 205-b may be provided by machine 120-a-n.

A third operating system session 205-b may be hosted by the operating system, CPU, and memory of machine 120-a-3, and the KVM functionality 210-a for the third operating system session 205-c may be provided by machine 120-a-5 over the local area network 115-a and the Internet 115-b. Input/output functionality from machine 120-a-5 may be mapped to the third operating system session 205-b using, for example, Internet Protocol (IP) packets. In certain examples, one or more KVM over IP devices may be used to translate KVM functionality at the remote machine 120-a-5 over the networks 115.

In one example, user 3 may log into the server computer system 105-a with remote machine 120-a-5 over the Internet 115-b and/or the local area network 115-a. The server computer system 105-a may apply one or more rules to select machine 120-a-2 as the session machine to host new operating system 205-c for user 3, and initiate the new operating system session 205-c for user 3 at machine 120-a-2. The server computer system 105-a may then facilitate the establishment of a session between the remote machine 120-a-5 and machine 120-a-2 such that KVM or other input/output functionality from the remote machine 120-a-5 is mapped to the operating system session 205-c running on machine 120-a-2.

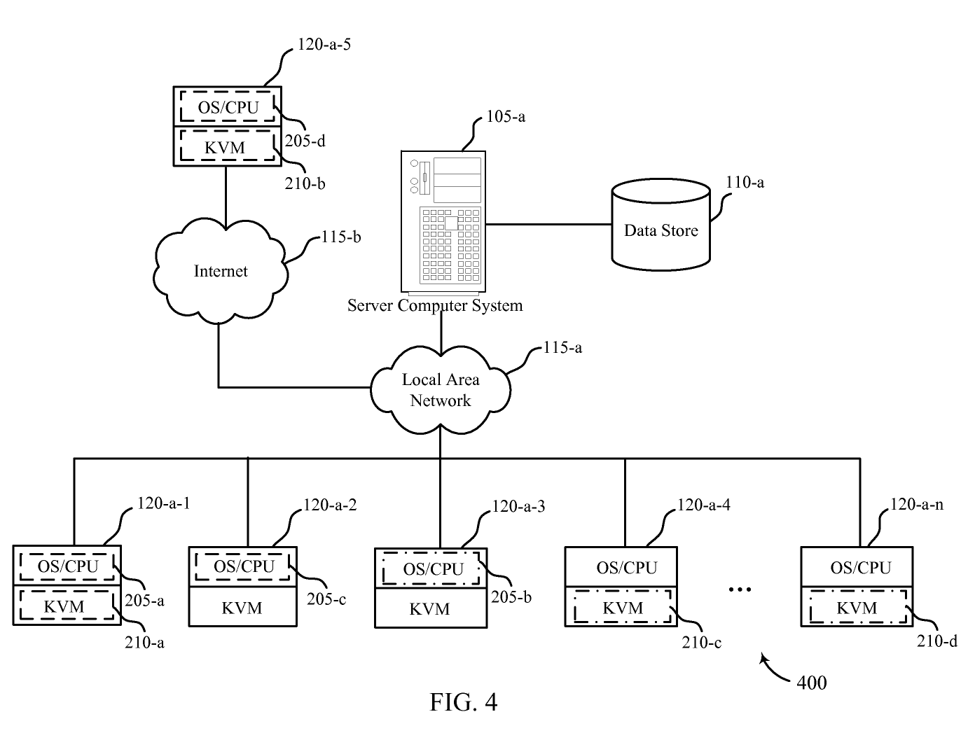

FIG. 4 illustrates another example of a system 400 for distributing desktops. The system 400 may be an example of the system 200 described above with reference to FIG. 2. The system 400 includes server computer system 105-a, local area network 115-a, the Internet 115-b, and machines 120-a.

Similar to the example of FIG. 3, machines 120-a-1 through 120-a-n, with the exception of remote machine 120-a-5, are communicatively coupled with local area network 115-a, and the remote machine 120-a-5 is indirectly coupled to the other machines 120-a via the Internet 115-b and the local area network 115-a. As shown in FIG. 4, a first operating system session 205-a may be hosted on the operating system, CPU, and memory of machine 120-a-1, and KVM functionality 210-a for the first operating system session 210-a may also be provided by machine 120-a-1. A second operating system session 205-b may be hosted by the operating system, CPU, and memory of machine 120-a-3, and the KVM functionality 210-b for the second operating system session 205-b may be provided by machine 120-a-n. A third operating system session 205-b may be hosted by the operating system, CPU, and memory of machine 120-a-3, and the KVM functionality 210-a for the third operating system session 205-c may be provided by machine 120-a-5 over the local area network 115-a and the Internet 115-b.

A fourth operating system session 205-d may be hosted by the operating system, CPU, and memory of remote machine 120-a-5, and the KVM functionality for the fourth operating system session 205-d may be provided by machine 120-a-n. The KVM functionality of machine 120-a-n may be mapped to the fourth operating system session 205-d over the local are network 115-a and the Internet 115-b. Thus, the KVM functionality of remote machine 120-a-5 may be decoupled from the operating system, CPU, and memory of to allow for the dynamic virtual distribution of operating system sessions among users of the different machines 120-a.

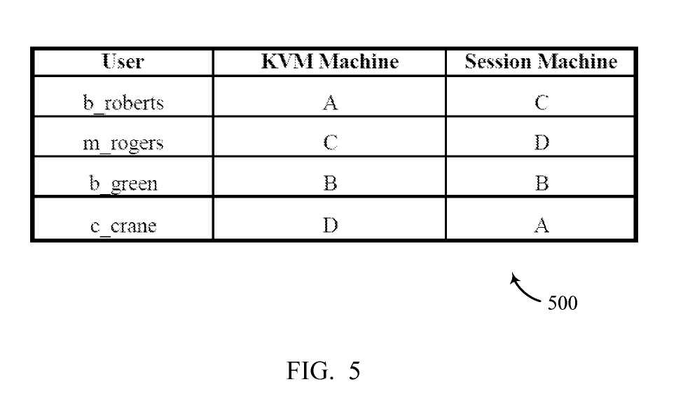

FIG. 5 is a diagram of an example of a mapping table 500 that may be used to track multiple operating system sessions, and to map KVM or other input/output functionality from each machine hosting an authenticated user to the machine hosting a corresponding operating system session for that authenticated user. The mapping table 500 may be maintained, for example, by the server computer system 105 of FIG. 1, FIG. 2A, FIG. 2B, FIG. 2C, FIG. 3, or FIG. 4. The mapping table may be stored in a data store (e.g., data store 110 of FIG. 1) associated with and/or implemented within the server computer system 105.

The mapping table 500 may record the results of applying one or more rules (e.g., at a rules engine) to one or more parameters to identify and select individual session machines to host operating system sessions for specific users and input/output machines to provide input/output (e.g., KVM) functionality to the operating system sessions. In certain examples, the rules engine may be implemented by the server computer system, and the set of rules may be stored in a data store associated with the server computer system.

As shown in the example of FIG. 5, authenticated user b_roberts may be currently logged in at machine A, which may provide KVM functionality to an operating system session for user b_roberts at machine C. Thus, the KVM functions of machine A may be at least partially detached from the CPU, operating system, and memory of machine A, and mapped to machine C. This mapping may occur over a direct connection between machine A and machine C and/or a network connection. In this way, user b_roberts may transparently access and control his or her operating system session on machine C from machine A as though machine A were hosting the operating system session.

As further shown in the example of FIG. 5, authenticated user m_rogers may use machine C to access an operating system session hosted by machine D. The KVM functionality of machine C may be mapped to the operating system session associated with user m_rogers at machine D. User b_green may access an operating system session hosted by machine B at machine B. Thus, the KVM functionality of machine B may be mapped to the operating system session associated with user b_green at machine B. In the case of user c_crane, a session may be hosted on machine A, but the user may not be currently logged in or authenticated at any machine. Consequently, no KVM functionality may be mapped to the session associated with user c_crane at machine A at present.

The table 500 shown in FIG. 5 may be dynamically updated as changes occur in the system. For example, whenever a new operating system session is created for a particular user, the session machine selected and identified by the rules engine to host the operating system session for that user may be recorded in the mapping table 500. Additionally, whenever an operating system session associated with a particular user is terminated, the machine hosting that operating system session may be removed from the listing associated with the user in the table 500. Moreover, as users log on and off of machines and the machines providing KVM functionality to individual operating system sessions change, these changes may be dynamically updated within the table 500.

The table 500 may be used by the server computer system to determine the appropriate action to take when a user logs on or off of a particular machine. For example, each time the server computer system authenticates login credentials received from a user at a machine in the network, the server computer system may search the table 500 to determine whether an entry for that user exists. If an entry exists for that user, the server computer system may identify a machine hosting a previously initiated operating system session associated with that user. If such an operating system session exists and KVM functionality is separable at the machine to which the user has logged in, the server computer system may apply one or more rules from the rules engine to select the machine hosting the previously initiated operating system session to continue hosting the operating system session. Alternatively, the server computer system may apply one or more rules from the rules engine to select and identify a different machine to host the operating system session for the user, terminate or transfer the operating system session for the user at the previous session machine, and initialize the operating system session for the user at the newly selected session machine.

The server computer system may also instruct the machine to which the user has logged in to communicate with the machine hosting the operating system session. Through this communication, the KVM functionality of the machine to which the user has logged in may be mapped to the operating system session associated with the user at the machine hosting the operating system session. Thus, the user may control the operating system session at the machine to which the user has logged in, and it may appear to the user as if the machine to which the user has logged in is hosting the operating system session associated with the user. In conjunction with this mapping, the server computer system may update the table 500 to reflect that the KVM machine to which the user has logged in is now mapped to the machine hosting the operating system session associated with the user.

The table 500 shown in FIG. 5 may also be used by the server computer system to prevent conflicts for the same resources from competing users or operating system sessions. For example, as shown in FIG. 5, machine D may host an operating system session for user m_rogers, but may not be providing KVM services to any user. Thus, machine D may appear to be open for a new user to log in. However, an operating system licensing agreement may prevent machine D from hosting more than one operating system session at a time.

If a user without an existing operating system session logs into machine D, the server computer system may apply one or more rules from the rules engine to the data in the table 500 to determine that machine D is unavailable to host an operating system session, select and identify another machine (e.g., machine E) to host the operating system session for the user, initiate the operating system session for the user at the newly selected session machine, map the KVM functionality of machine D to machine E, and update the table 500 accordingly. Additionally or alternatively, the server computer system may apply one or more rules to suspend or terminate a running operating system session for a user that is not logged into any machine (e.g., user c_crane in FIG. 5), thereby freeing up resources for the user logging in.

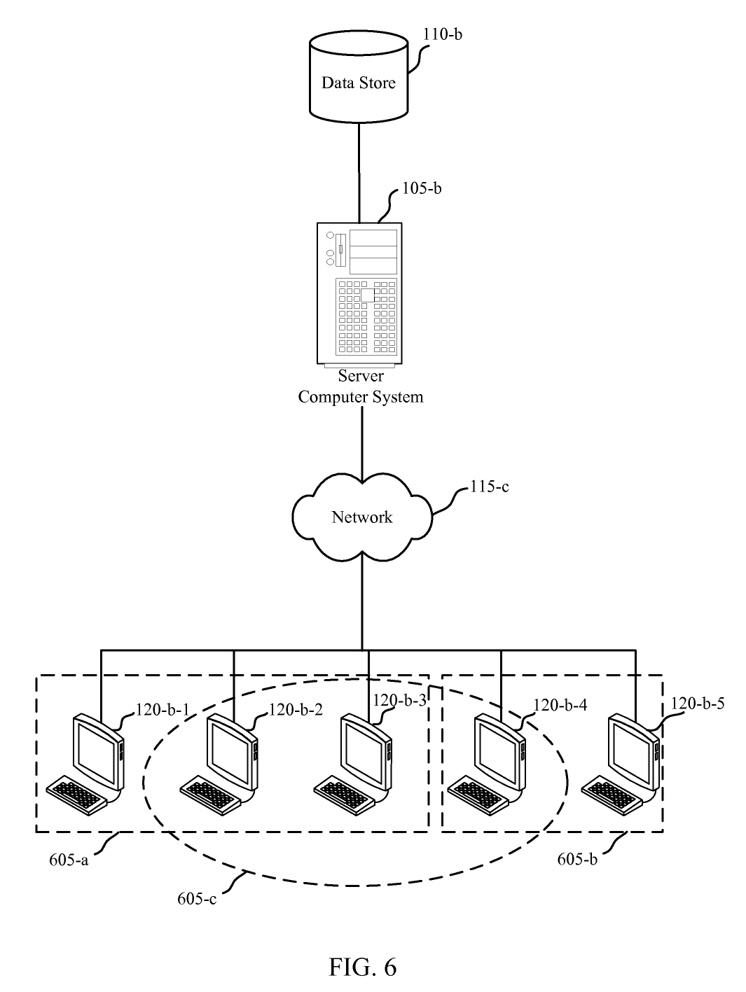

FIG. 6 illustrates another example of a system 600 in which a server computer system 105-b is communicatively coupled with a number of machines 120 over a network 115-b. The system 600 may be an example of one or more of the systems 100, 200, 300, 400 described above with reference to FIG. 1, FIG. 2, FIG. 3, or FIG. 4.

The server computer system 600 may communicate with a data store 110-b. The data store 110-b may store a set of rules for identifying a session machine from the plurality of machines 120-b to host an operating system session associated with a user. When a user logs in to one of the machines 120-b and is authenticated at the server computer system 105-b, the server computer system 105-b may gather information about the user and apply a set of rules to the information to determine an appropriate session machine to host an operating system session for that user. In certain examples, one or more of the rules may be specific to the user. In additional or alternative examples, one or more of the rules may be general rules which are applicable to multiple users.

In the example of FIG. 6, the machines 120-b may be partitioned into a first group 605-a associated with a first location, a second group 605-b associated with a second location, and a third group 605-c of machines 120-b which have a special-purpose software application installed. The selection of a session machine 120-b for a particular user may be subject to at least a first rule which gives preference to machines in the first location and a second rule which gives preference to machines having the special-purpose software application installed.

Thus, in one example the user may log on to machine 120-b-1, and even though machine 120-b-1 is in the first location and available to host an operating system session for the user, server computer system 105-b may apply the first and second rules to determine that machine 120-b-3 may be a more suitable host for the operating system session and instantiate the operating system session at machine 120-b-3. KVM or other input/output functionality may then be mapped from machine 120-b-1 to the operating system session for the user on session machine 120-b-3.

In another example, the user may log on to machine 120-b-2, and the server computer system 105-b may determine that machine 120-b-2 is already hosting an operating system session for a different user. If licensing agreements or available processing resources prevent machine 120-b-2 from hosting both operating system sessions, the server computer system 105-b may apply one or more rules to determine that machine 120-b-3 may be a more suitable candidate session machine for the user. Consequently, the server computer system 105-b may select machine 120-b-3 as the session machine for a new operating system session associated with the user, and the KVM or other input/output functionality of machine 120-b-2 may be mapped to the operating system session associated with the user hosted by machine 120-b-3.

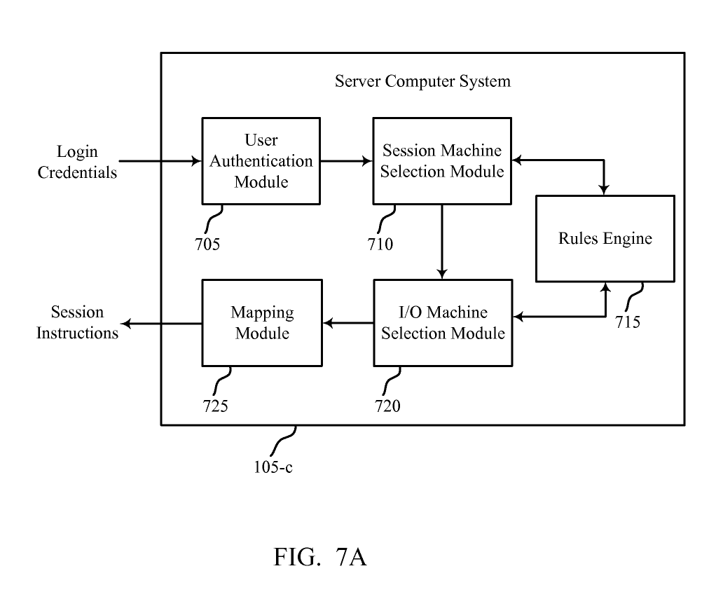

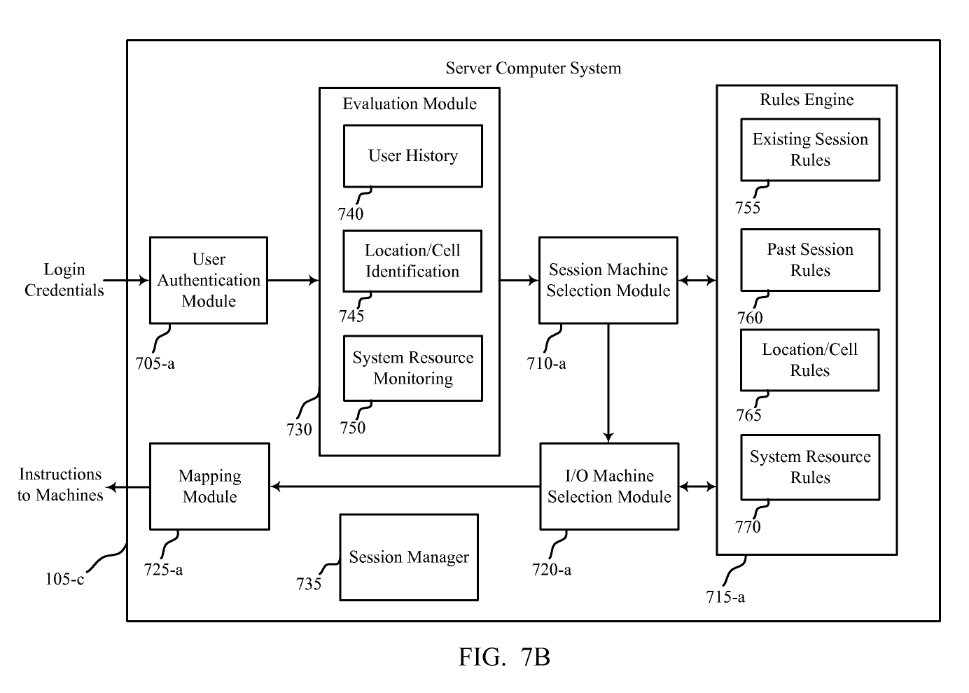

FIG. 7A illustrates an example of a server computer system 105-c consistent with the principles described above. The server computer system 105-c may be an example of the server computer system 105 described above with reference to FIG. 1, FIG. 2A, FIG. 2B, FIG. 2C, FIG. 3, FIG. 4, or FIG. 6.

As shown in FIG. 7A, the server computer system 105-c of the present example includes a user authentication module 705, a session machine selection module 710, a rules engine 715, an input/output machine selection module 720, and a mapping module 725. Each of these components may be in communication, directly or indirectly. In certain examples, one or more of the modules 705, 710, 715, 720, 725 of the server computer system 105-c may be implemented by hardware configured to execute special-purpose code. Additionally or alternatively one or more of the modules 705, 710, 715, 720, 725 of the server computer system 105-c may be implemented by hardware alone.

The server computer system 105-c may communicate with a plurality of machines, each of which may be configured to execute and host at least one operating system session and provide input/output functionality to at least one operating system session. For at least some of the machines, the input/output functionality may be implemented independently from the at least one operating system session such that a first machine is capable of hosting a first operating system session, with input/output functionality of the first operating system session being controlled by a second machine, while the first machine concurrently provides input/output functionality to a second operating system session hosted by a third machine.

The user authentication module 705 may be configured to communicate with a machine to authenticate a user at the machine. For example, the user may provide a username, password, key card credentials, key fob credentials, biometric credentials, and/or other credentials to the machine, which may be received at the user authentication module 705 to verify the identity of the user. The credentials received for the user at the user authentication module 705 may be associated with a system used by the server computer system 105-c to manage operating system sessions. In certain examples, the credentials may be associated with a user account in an enterprise network.

Once the user at the machine has been authenticated by the user authentication module 705, the session machine selection module 710 may select one of the machines communicatively coupled with the server computer system 105-c to host an operating system session for the user. In certain examples, the selection of a machine to host the operating system session for the user may be based on one or more rules enforced at the rules engine 715. In certain examples, one or more rules may be used to select the session machine based on a determination of whether a previously initiated operating system session already exists for the user. For example, the session machine selection module 710 may determine that an operating system session associated with the user is already exists on a second machine. In this example, the session machine selection module 710 may elect to allow the second machine to continue hosting the operating system session, thereby selecting the second machine as the host for the operating system session associated with the user.

In other examples, the session machine selection module 710 may determine that a previously initiated operating system session exists for the user, but the previously initiated operating system session may be inadequate for an intended purpose, or expired. Alternatively, the session machine selection module 710 may determine that no operating system session for the user is currently running In such examples, the session machine selection module 710 may elect a machine to host a new operating system session associated with the user. In certain examples, when a new operating system session is elected, any existing operating system session that is also associated with the user may be terminated or suspended.

To select a machine to host a new operating system session for the user, the session machine selection module 710 may examine a record of current machines and operating system sessions to identify an available host for the new operating system session. In certain examples, this record may include a table such as the table 500 shown in FIG. 5. First priority may be given to the machine on which the user is logged in, if that machine is available. Otherwise, another available machine may be selected as the session machine to host the operating system session for the user. The session machine selection module 710 may consult the rules engine 715 to apply one or more rules associated with the user and/or one or more generally applicable rules to select and identify the session machine, as described above. The session machine selection module 710 may make a record of the session machine selected to host the operating system session.

Where a new operating system session is to be created for the user, the session machine selection module 710 may be configured to instantiate the operating system session at the selected host machine. In certain examples, this may include retrieving one or more user profile files associated with the user from a data store or other repository and providing the user profile files to the machine hosting the operating system session for the user. In certain examples, a specific type of operating system (e.g., Windows, Linux, OS/X, Unix, etc.) may be selected and instantiated for the operating system session. In some embodiments, a new virtual machine may be spun up at the host machine to implement the operating system session.

The input/output machine selection module 720 may be configured to communicate with the rules engine 715 to select a machine to provide input/output functionality (e.g., KVM functionality) for the operating system session associated with the user. In many cases, the input/output machine selection module 720 may automatically select the machine on which the user is logged in to provide the input/output functionality. For example, if a user provides login credentials at a first machine, the server computer system 105-c may assume that the user intends to stay at the first machine and select the first machine to provide KVM functionality to the operating system session for the user. However, in alternative embodiments, a different machine may be selected to provide input/output functionality to the operating system session for the user.

The mapping module 725 may be configured to map the input/output functionality of the machine selected at the input/output machine selection module 720 to the operating system session hosted by the machine selected at the session machine selection module 710. The mapping module 725 may accomplish this mapping by instructing the machine selected by the input/output machine selection module 720 to communicate with the machine selected by the session machine selection module 710 directly or over a network. For example, the mapping module 725 may instruct the machine selected to provide input/output functionality to establish a connection with the machine selected to host the operating system session over a network, such that the user may control the operating system session at the machine selected to provide input/output functionality.

FIG. 7B illustrates another example of a server computer system 105-d consistent with the principles described above. The server computer system 105-d of FIG. 6B may be an example of the server computer system 105 described above with reference to FIG. 1, FIG. 2A, FIG. 2B, FIG. 2C, FIG. 3, FIG. 4, FIG. 6, or FIG. 7A.

As shown in FIG. 7B, the server computer system 105-d of the present example includes a user authentication module 705-a, a session machine selection module 710-a, a rules engine 715-a, an input/output machine selection module 720-a, a mapping module 725-a, an evaluation module 730, and a session manager 735. Each of these components may be in communication, directly or indirectly. In certain examples, one or more of the modules 705-a, 710-a, 715-a, 720-a, 725-a, 730, 735 of the server computer system 105-d may be implemented by hardware configured to execute special-purpose code. Additionally or alternatively one or more of the modules 705-a, 710-a, 715-a, 720-a, 725-a, 730, 735 of the server computer system 105-d may be implemented by hardware alone.

The user authentication module 705-a, the session machine selection module 710-a, the rules engine 715-a, the input/output machine selection module 720-a, and the mapping module 725-a may be examples of the user authentication module 705, session machine selection module 710, rules engine 715, input/output machine selection module 720, and mapping module 725 described above, respectively, with reference to FIG. 7A. Thus, the user authentication module 705-a may authenticate a user of a machine, the session machine selection module 710-a may select a machine to host an operating system session for the user (and, in some examples, initiate the operating system session), the rules engine 715 may enforce a set of rules to assist in the selection of a session machine and an input/output machine, and the input/output machine selection module 720-a may select a machine to provide input/output functionality to the operating system session for the user. The mapping module 725-a may map the input/output functionality of the machine selected at the input/output machine selection module 720-a to the operating system session hosted for the user by the machine selected at the session machine selection module 710-a.

The rules engine 715-a of the present example includes existing session rules 755 module, past session rules 760 module, location/cell rules 765 module, and system resource rules 770 module.

The evaluation module 730 may gather information about the user, machines, or system that may be used by the session machine selection module 710-a and the rules engine 715 to select a machine to host the operating system session for the user and/or by the input/output machine selection module 720-a to select a machine to provide input/output functionality to the operating system session for the user. To this end, the evaluation module 730 may include a user history submodule 740, a location/cell identification submodule 745, and a system resource monitoring submodule 750.

For example, the user history submodule 740 may evaluate whether the user currently has an active operating system session, and where current active operating system session is located and/or where past operating system sessions were located. The location/cell identification submodule 745 may use various location determination techniques to determine the location and/or machine from which the user is logging on, and whether that machine or location is associated with any cell or group for allocation purposes. The system resource monitoring submodule 750 may monitor available resources associated with the various machines, including licensing restrictions, to determine appropriate candidates for hosting the operating system session or providing input/output functionality to the operating system session.

The session manager module 735 may include an Application Programming Interface (API) architecture which serves as the communication control point, managing existing operating system sessions and brokering new operating system sessions. The server computer system 105-d may include a centralized management console (not shown), which may be a web-based management console for configuration, real-time monitoring, and reporting. Additional management capabilities may exist for the entire virtual desktop/application distribution environment. It is worth noting that while the system has been described as a whole, individual aspects may be broken out and used exclusive of other aspects of the system.

Consider the example of a user logging on at a machine (e.g., machine 120 of FIG.

1), and that the machine sends a query to the server computer system 105-d. User authentication module 705-a may receive the query, and perform authentication procedures to authenticate the user logging on. Once authenticated, the session machine selection module 710-a may communicate with the evaluation module 730 and the rules engine 715-a to identify and select a session machine to host an operating system session for the user. The user history submodule 740 of the evaluation module 730 may evaluate whether the user has a currently active session, and a recent history of where the user sessions were located. The location/cell identification submodule 745 of the evaluation module 730 may use various location determination techniques to determine the location of the machine where the user is logging on from, and whether that machine is associated with any cell or group for allocation purposes. The system resource monitoring submodule 750 of the evaluation module 730 may monitor the available resources associated with the machines in the network, evaluating such factors as available processing resources, historic load, etc.

The rules engine 715-a may then use the information gathered by the evaluation module 730 to determine which machine(or set of machines) will serve the session. The existing session rules 755 may include rules dictating that, when a user has an active session on a given machine (but has logged off and moved to a new machine), the session will remain active when the user moves and that the machine running the session will continue to do so. However, if the user has moved to a new location in an organization, there may also be rules related to reselection of a serving machine to run the session. The past session rules 760 may include rules dictating that, when a user is associated with a recently deactivated session on a given machine (e.g., inactive for a time period less than a threshold), that machine may be given preference to run the new session.

The location/cell rules 765 may include rules dictating which machines may be used based on location of the query. Certain types, classes, cells, and other groupings of machines may be used to partition resources, and efficiently allocate resources for sessions. The system resource rules 770 may include rules about how machines will be allocated for sessions based on performance threshold for both users and machines (e.g., there may be a minimum performance threshold to exceed before a machine may be identified to run a session).

Thus, the rules engine 715-a may be configured to dynamically select a machine (e.g., a machine 120 of FIG. 1) to run a session based on the factors set forth above. Upon notification or receipt of a query from a user to initiate an operating system session, the rules engine 715-a may work with the session machine selection module 710-a to access a set of rules and parameters to determine the correct session machine to host the operating system session. The rules engine 715-a may make this determination based on the location, performance attributes of the available pool, attributes of the user, and other factors may also be used by the rules engine 715-a.

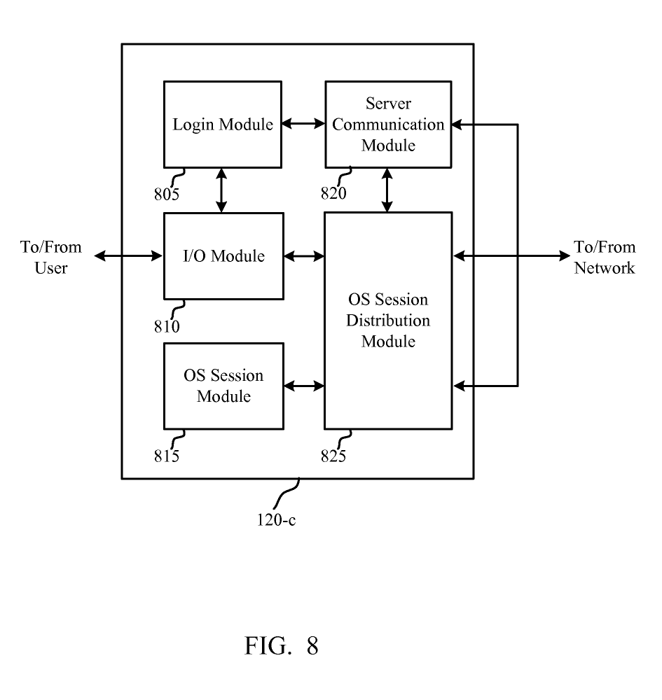

FIG. 8 illustrates an example of a machine 120-c that may be used to host an operating system session and/or provide input/output functionality to an operating system session consistent with the principles described above. The machine 120-c of FIG. 8 may be an example of the machine 120 described above with reference to FIG. 1, FIG. 2A, FIG. 2B, FIG. 2C, FIG. 3, FIG. 4, or FIG. 6.

As shown in FIG. 8, the machine 120-c of the present example includes a login module 805, an input/output module 810, an operating system session module 815, a server communication module 820, and an operating system session distribution module 825. Each of these components may be in communication, directly or indirectly. In certain examples, one or more of the modules 805, 810, 815, 820, 825 of the machine 120-c may be implemented by hardware configured to execute special-purpose code. Additionally or alternatively one or more of the modules 805, 810, 815, 820, 825 of the machine 120-c may be implemented by hardware alone.

The login module 805 of the machine 120-c may be configured to receive login credential from a user of the machine 120-c. The login credentials may include, but are not limited to, a username, password, keycard credentials, key fob credentials, and biometric credentials. The login credentials may identify the user of the machine 120-c to a server computer system (e.g., the server computer system 105 described above with reference to FIG. 1, 2A, 2B, 2C, 3, 4, 6, 7A, or 7B). The server communication module 820 may transmit the received login credentials to the server computer system to authenticate the user.

If the user is authenticated based on the credentials provided, the server communication module 820 may communicate with the server computer system to identify a machine to host an operating system session for the user. In certain examples, an operating system session associated with the user may already exist on another machine. In such cases, the server may identify the other machine as the host for the operating system session for the user. Additionally or alternatively, the server may identify a machine for instantiating a new operating system session for the user. The machine identified for instantiating the new operating system may be machine 120-c, or another machine.

The input/output module 810 of the machine 120-c may provide input/output functionality to the user. For example, the input/output module may include peripheral devices and drivers to interface with the user. In certain examples, the input/output module 810 may include a keyboard, monitor or other display device, and mouse or other cursor device to provide KVM functionality to the user. In certain examples, a single device such as a touchscreen may implement one, more, or all input/output functions. The input/output module 810 may serve as an interface between the user and the login module 805 when the user logs in to the machine 120-c or a network. Once a machine has been identified as a host for an operating system session for the user, the operating system distribution module 825 may map the input/output module 810 to the operating system session. If the operating system session is hosted at a machine other than 120-c, this mapping may occur over a network or direct connection between the machine 120-c and the external host machine.

The operating system session module 815 may be configured to host one or more operating system sessions associated with individual users. The operating system session hosted by the operating system session module 815 may include an operating system session for the user of the machine 120-c or for a user of another machine. Because the input/output module 810 may be independent from the operating system session module 815, the input/output module 810 may be mapped to the operating system session module 815 of the present machine 120-c or detached completely from the operating system session module 815 of the present machine 120-c and mapped to an operating system session hosted by an external machine.

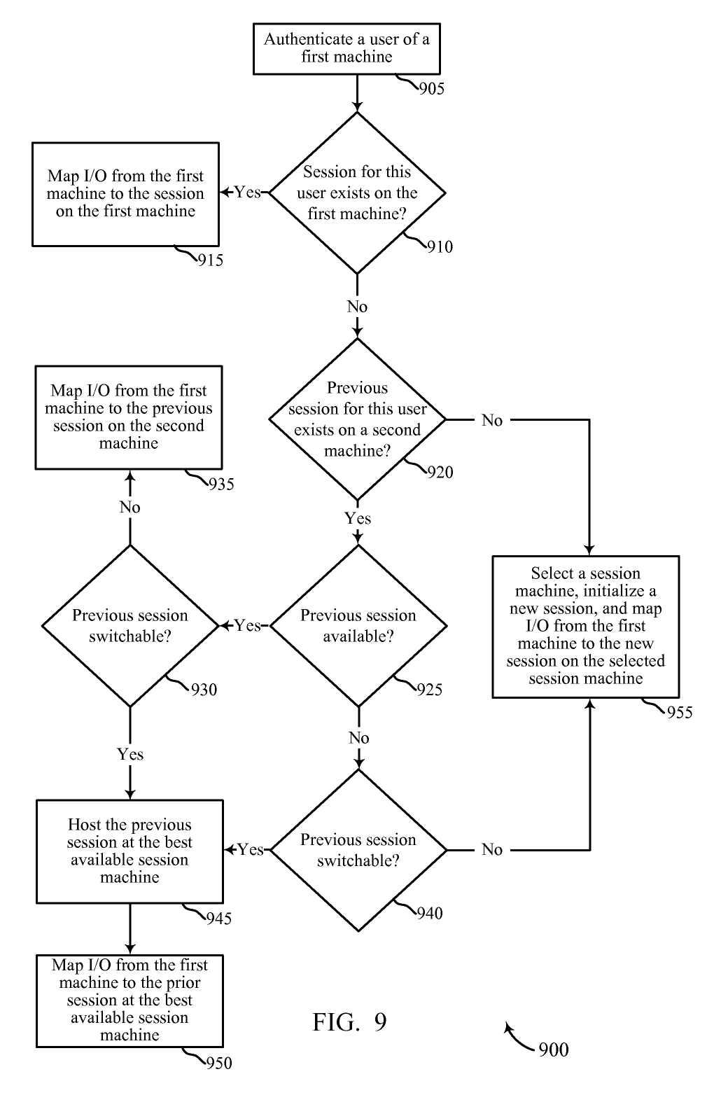

FIG. 9 is a flowchart diagram of an example method 900 of providing distributed virtual desktops. The method 900 may be implemented, for example, at a server computer system such as the server computer system 105 described above with reference to FIG. 1, FIG. 2A, FIG. 2B, FIG. 2C, FIG. 3, FIG. 4, FIG. 7A, or FIG. 7B.

At block 905, a user at a first machine of a plurality of machines communicatively coupled with the server computer system is authenticated. At block 910, a determination is made as to whether an operating system session for the user exists on the first machine. If an operating system session for the user exists on the first machine, the input/output functionality of the first machine is mapped to the existing session associated with the user on the first machine at block 915. The input/output functionality may include KVM and/or other input/output functionality provided by the first machine to the user.

If no operating system session for the user currently exists on the first machine, a determination is made at block 920 as to whether a previously initiated operating system associated with the user exists on another machine. For example, if the user previously logged in to and used the other machine, an operating system session associated with the user may still be running or suspended at the other machine. The server computer system may communicate with other machines to make this determination.

If no operating system session for the user currently exists on the first machine (block 910, No) and a previously initiated operating system session exists on a second machine (block 920, Yes), a determination may be made at block 925 as to whether the previously initiated operating system session for the user is available. The previously initiated operating system session may be unavailable, for example, if the second machine currently hosting the previously initiated operating system is actively being used to host a different operating system session or if the second machine is powered down. It may also be determined at blocks 930 and 940 whether the previously initiated operating session for the user hosted by the second machine is switchable. The previously initiated operating system may be switchable if the session may be transferred to a different host computer.

If the previously initiated operating system session is available but not switchable (block 925, Yes, block 930, No), the second machine may be selected to continue hosting the session, and the input/output functionality from the first machine may be mapped at block 935 to the previously initiated session on the second machine.

If the previously initiated operating system is available and switchable (block 925, Yes, block 930, Yes) or unavailable and switchable (block 925, No, block 940, Yes), at block 945 the previously initiated session may be hosted at the best available session machine. For example, the best available session machine may be a host machine with the most available resources or a library of software better suited to the needs of the user. In certain examples, the best available session machine may be the second machine if the second machine is available. Alternatively, the server computer system may select the first machine or another machine as the best available session machine and transfer the previously initiated session to that machine for hosting. Where the server computer system selects the best available session machine to host the previously initiated session, the input/output functionality from the first machine is mapped to the previously initiated session at the selected best available session machine at block 950.

If the previously initiated session for the user on the second machine is unavailable and unable to be switched (block 925, No, block 940, No), or if no previously initiated session currently exists for the user (block 920, No), the server computer system may select a host machine based on any applicable criteria and initiate a new operating system session for the user on the new host machine at block 955. The input/output functionality from the first machine may be mapped to the new operating system session for the user on the new host machine.

In the example shown in FIG. 9, authentication of the user may occur prior to mapping the input/output functionality provided at the first machine to the operating system session hosted by the session machine. However, it should be understood that alternatively, the mapping may begin or complete prior to authentication of the user. In certain examples, the server computer system may identify the user prior to the mapping (e.g., identifying the user and associating the user with the first machine, or associating the user with a location), begin the mapping, and then authenticate the user during the mapping or after mapping the mapping has begun or finished. Doing so may provide the user faster access to the operating system session.

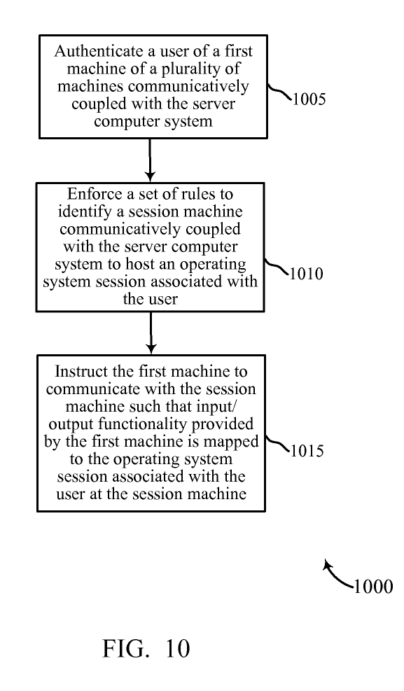

FIG. 10 is a flowchart diagram of an example method 1000 of providing distributed virtual desktops. The method 1000 may be implemented, for example, at a server computer system such as the server computer system 105 described above with reference to FIG. 1, FIG. 2A, FIG. 2B, FIG. 2C, FIG. 3, FIG. 4, FIG. 7A, or FIG. 7B. The method 1000 may be an example of the method 900 described above with reference to FIG. 9.

At block 1005, a user at a first machine of a plurality of machines communicatively coupled with the server computer system is authenticated. At block 1010, a set of rules is enforced to identify a session machine communicatively coupled with the server computer to host an operating system session associated with the user. The set of rules may be enforced with a rules engine. The rules may be stored in a data store in communication with the server computer system, and/or a data store that is a component of the server computer system.

The session machine may be selected based on any number of criteria. For instance, the session machine may be selected based at least in part on the identity of the user. For example, one or more machines may be associated with the user as default or preferred machines. The set of machines associated with the user may be ordered according to a predetermined priority, and this predetermined priority may factor into the selection of one of the machines in the set of machines associated with the user as the session machine. In additional or alternative examples, the set of rules may grant specific users permission to access only some of the machines. In other examples, the set of rules enforced to select and identify the session machine may prioritize one or more machines based on a desirability or applicability of each machine based on a type of work performed by the user. For example, if the user typically utilizes special-purpose software, machines having that special-purpose software installed may be better candidates for selection as the session machine for the user.

In additional or alternative examples, the set of rules may dictate the selection of the session machine based at least in part on a location of the user. For example, the session machine may be selected from a number of candidate machines within a set distance from the current location of the user. In additional or alternative examples, the session machine may be selected based at least in part on the processing capabilities or resources available from one or more candidate session machines.

In certain examples, the first machine may be selected and identified as the session machine in response to a determination that the first machine is capable of hosting the operating system session associated with the user. In alternative examples, a machine separate from the first machine may be selected as the session machine.

At block 1015, the first machine is instructed to communicate with the identified session machine such that input/output functionality provided by the first machine is mapped to the operating system session associated with the user at the session machine. In examples where the session machine is separate from the first machine, this communication and mapping may occur over, for example, over a network connection or a direct connection between the first machine and the session machine. In examples where the first machine is selected as the session machine, an independent input/output module of the first machine may be logically or physically mapped to the operating system session running on the first machine.

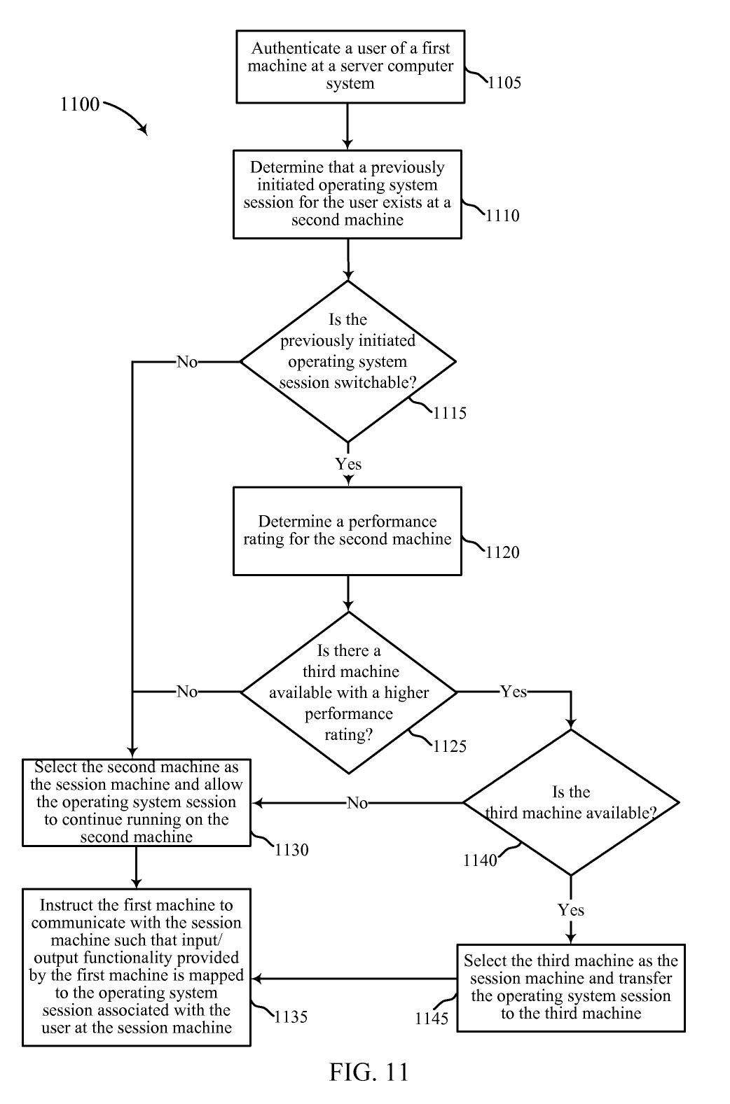

FIG. 11 is a flowchart diagram of an example method 1100 of providing distributed virtual desktops. The method 1100 may be implemented, for example, at a server computer system such as the server computer system 105 described above with reference to FIG. 1, FIG. 2A, FIG. 2B, FIG. 2C, FIG. 3, FIG. 4, FIG. 7A, or FIG. 7B. The method 1100 may be an example of the method 900 described above with reference to FIG. 9 or the method 1000 described above with reference to FIG. 10.

At block 1105, a user of a first machine is authenticated at a server computer system. At block 1110, it is determined that a previously initiated operating system session for the user exists at a second machine. At block 1115, a determination is made as to whether the previously initiated operating system is switchable. If the previously initiated operating system is not switchable, the second machine is selected and identified as the session machine and the operating system session is allowed to continue running on the second machine at block 1130. The first machine may then be instructed at block 1135 to communicate with the session machine such that input/output functionality provided by the first machine is mapped to the operating system session associated with the user at the session machine.

If the previously initiated operating system session is switchable (block 1115, Yes), a performance rating may be determined for the second machine at block 1120, and a determination may be made at block 1125 of whether a third machine with a higher performance rating exists. The performance rating for the second and third machines may be a score assigned to each machine which indicates a desirability or suitability of that particular machine to host the previously initiated operating system session. The performance rating for a machine may be a composite of a number of weighted factors, including processing capabilities of the machine, available resources of the machine, a location of the machine, software installed on the machine, peripheral or auxiliary devices associated with the machine, a popularity of the machine, and/or any other relevant factor.

In the event that a third machine exists with a higher performance rating than the second machine (block 1125, Yes), a determination may be made at block 1140 of whether the third machine is available. If the third machine is available (block 1140, Yes), the third machine may be selected and identified as the session machine at block 1145, and the operating system session may transferred from the second machine to the third machine. At block 1135, the first machine may be instructed to communicate with the session machine such that the input/output functionality provided by the first machine is mapped to the operating machine session associated with the user at the session machine.

In the event that no third machine with a higher performance rating than the second machine exists (block 1125, No), or if such a third machine exists and is not available (block 1140, No), the second machine may be selected and identified as the session machine at block 1130, and the operating system session may continue running on the second machine. At block 1135, the first machine may be instructed to communicate with the session machine such that the input/output functionality provided by the first machine is mapped to the operating machine session associated with the user at the session machine.

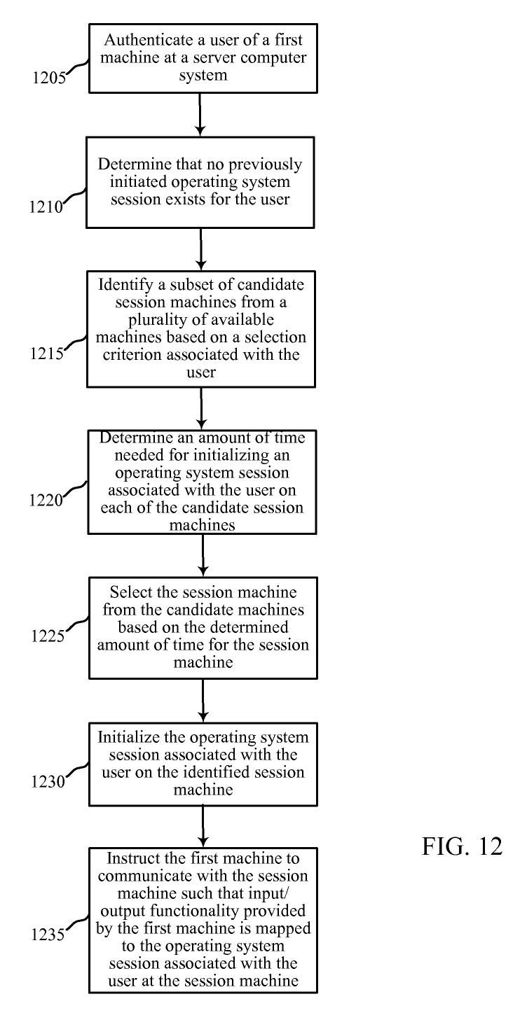

FIG. 12 is a flowchart diagram of an example method 1200 of providing distributed virtual desktops. The method 1200 may be implemented, for example, at a server computer system such as the server computer system 105 described above with reference to FIG. 1, FIG. 2A, FIG. 2B, FIG. 2C, FIG. 3, FIG. 4, FIG. 7A, or FIG. 7B. The method 1200 may be an example of the method 900 described above with reference to FIG. 9, the method 1000 described above with reference to FIG. 10, and/or the method 1100 described above with reference to FIG. 11.

At block 1205, a user of a first machine is authenticated at a server computer system. At block 1210, it is determined that no previously initiated operating system session exists for the user. At block 1215, a subset of candidate session machines is identified from a plurality of available machines based on a selection criterion associated with the user. As described above, the subset of candidate session machines may be selected based on any relevant selection criterion. For example, the candidate session machines may be selected based on a set of rules associated with the identity of the user. Additionally or alternatively, the candidate session machines may be selected based on their locations with respect to a location of the user. Additionally or alternatively, the candidate session machines may be selected based on their respective processing capabilities or an amount of processing resources available at each of the candidate session machines.

At block 1220, an amount of time associated with initializing a new operating system session for the user on each of the candidate session machines is determined. The amount of time may be dynamically calculated for one or more of the candidate session machines. Additionally or alternatively, the amount of time for one or more of the candidate session machines may be stored in a data store associated with the server computer system. At block 1225, the session machine is selected and identified from the candidate session machines based on the determined amount of time for the session machine. In certain examples, the candidate session machine with the lowest determined amount of time for the initializing the new operating system session is selected as the session machine. Additionally or alternatively, other factors such as the requirements associated with the user, the location of the session machine with respect to the user, hardware associated with the session machine, and the like may factor into the selection of the session machine.

At block 1230, the new operating system session associated with the user is initialized on the identified session machine. At block 1235, the first machine is instructed to communicate with the identified session machine such that the input/output functionality (e.g., KVM and other peripheral I/O functionality) provided by the first machine is mapped to the operating system session associated with the user at the session machine.

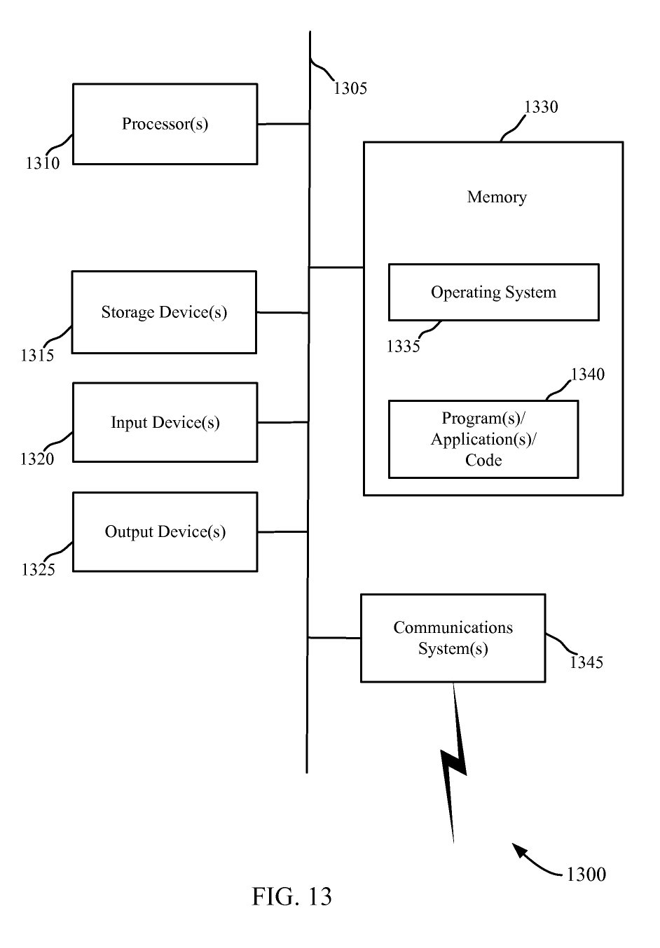

A device structure 1300 that may be used for a server computer system 105, a machine 120, or other computing devices described herein, is illustrated with the schematic diagram of FIG. 13. This drawing broadly illustrates how individual system elements of each of the aforementioned devices may be implemented, whether in a separated or more integrated manner. The exemplary structure is shown comprised of hardware elements that are electrically coupled via bus 1305, including processor(s) 1310 (which may further comprise a DSP or special-purpose processor), storage device(s) 1315, input device(s) 1320, and output device(s) 1325. The storage device(s) 1315 may be a machine-readable storage media reader connected to any machine-readable storage medium, the combination comprehensively representing remote, local, fixed, or removable storage devices or storage media for temporarily or more permanently containing computer-readable information. The communications systems interface 1345 may interface to a wired, wireless, or other type of interfacing connection that permits data to be exchanged with other devices. The communications system(s) 1345 may permit data to be exchanged with a network.

The structure 1300 may also include additional software elements, shown as being currently located within working memory 1330, including an operating system 1335 and other code 1340, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

The components described herein may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. The functions of each unit may also be implemented, in whole or in part, with instructions embodied in a memory, formatted to be hosted by one or more general or application-specific processors.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a sim card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A system for providing distributed virtual desktops, the system comprising:
a plurality of machines, each machine being configured to host at least one operating session and provide an input/output functionality;
a data store configured to store a set of rules for identifying a session machine from the plurality of machines to host an operating system session associated with a user; and
a server computer system communicatively coupled with the data store and with each of the machines, wherein the server computer system is configured to:
authenticate the user at a first machine of the plurality of machines;
enforce the set of rules to identify a session machine from the plurality of machines to host an operating system associated with the user; and
instruct the first machine to communicate with the identified session machine such that the input/output functionality provided by the first machine is mapped to the operating system session associated with the user at the session machine.

2. The system of claim 1, wherein the server computer system is further configured to:
determine that a previously initiated operating system session associated with the user exists on a second machine; and
identify the second machine as the session machine.

3. The system of claim 1, wherein the server computer system is further configured to:
determine that a previously initiated operating system session associated with the user exists on a second machine;
identify a third machine as the session machine; and
transfer the previously initiated operating system session to the third machine.

4. The system of claim 1, wherein the server computer system is further configured to:
initiate a new operating system session on the session machine as the operating system session associated with the user.

5. The system of claim 1, wherein the server computer system is further configured to:
identify the first user prior to mapping the input/output functionality of the first machine to the operating system session hosted by the session machine; and
wherein the authenticating the first user at the first machine occurs after the mapping the input/output functionality of the first machine to the operating system session hosted by the session machine.

6. A method of providing a distributed virtual desktop, the method comprising:
authenticating a user of a first machine communicatively coupled with a server computer system;
enforcing a set of rules to identify a session machine communicatively coupled with the server computer system to host an operating system session associated with the user; and
instructing the first machine to communicate with the session machine such that input/output functionality provided by the first machine is mapped to the operating system session associated with the user at the session machine.

7. The method of claim 6, further comprising:
determining an amount of processing resources available from each machine in a set of candidate session machines; and
selecting the session machine based on at least the amount of processing resources available from the session machine.

8. The method of claim 6, further comprising:
identifying a set of machines associated with the user; and
selecting one of the machines associated with the user as the session machine.

9. The method of claim 6, further comprising:
determining a location of the user; and
selecting the session machine based on at least the location of the user.

10. The method of claim 6, further comprising:
identifying a subset of candidate session machines from a plurality of available machines;
determining an amount of time associated with initializing the operating system session associated with the user for at least one of the candidate session machines; and
selecting the session machine from the candidate session machines based on the determined amount of time.

11. The method of claim 6, wherein the enforcing the set of rules comprises:
determining that a previously initiated operating system session associated with the user exists on a second machine.

12. The method of claim 11, wherein the enforcing the set of rules further comprises:
identifying the second machine as the session machine.

13. The method of claim 11, wherein the enforcing the set of rules further comprises:
determining that a third machine has more resources available for the previously initiated operating system session than the second machine; and
identifying the third machine as the session machine.

14. The method of claim 13, wherein:
the identifying the third machine as the session machine occurs in response to determining that the previously initiated operating system session is portable from the second machine to the third machine.

15. The method of claim 6, further comprising:
determining that the first machine is capable of hosting the operating system session associated with the user; and
identifying the first machine as the session machine.

16. The method of 6, further comprising:
identifying the first user prior to mapping the input/output functionality of the first machine to the operating system session hosted by the session machine; and
wherein the authenticating the first user at the first machine occurs after the mapping the input/output functionality of the first machine to the operating system session hosted by the session machine

17. The method of claim 6, wherein:
the input/output functionality of the first machine comprises keyboard video mouse (KVM) functionality.

18. A server computer system, comprising:
a user authentication module configured to authenticate a user of a first machine communicatively coupled with the server computer system;
a session machine selection module configured to enforce a set of rules to identify a session machine communicatively coupled with the server computer system to host an operating system session associated with the user; and
a mapping module configured to instruct the first machine to communicate with the session machine such that input/output functionality provided by the first machine is mapped to the operating system session associated with the user at the session machine.

19. The server computer system of claim 18, wherein the session machine selection module is further configured to:
determine that a previously initiated operating system session associated with the user exists on a second machine; and
identify the second machine as the session machine.

20. The server computer system of claim 18, wherein the session machine selection module is further configured to:
identify a subset of candidate machines from a plurality of available machines based on at least one selection criterion associated with the user; and
identify the session machine from the subset of candidate machines.

21. The server computer system of claim 20, wherein the session machine selection module is further configured to:
determining an amount of time associated with initializing the operating system session associated with the user for at least one of the candidate machines; and
identifying the candidate machine based on the determined amount of time.

22. The server computer system of claim 18, wherein the session machine selection module is further configured to:
determine that the first machine is capable of hosting the operating system session associated with the user; and
identify the first machine as the session machine.
